(19) United States
(12) Patent Application Publication
(10) Pub. No.: US 2024/0323603 A1
(43) Pub. Date: Sep. 26, 2024

(54) Reducing Intermodulation Distortion Effects in Hearable Devices

(71) Applicant: Google LLC, Mountain View, CA (US)

(72) Inventors: Timothy Arthur Gladwin, Sunnyvale, CA (US); YaoJen Liu, Taiper (TW)

(73) Assignee: Google LLC, Mountain View, CA (US)

(21) Appl. No.: 18/125,615

(22) Filed: Mar. 23, 2023

(51) Int. Cl. H04R 3/04

(52) U.S. Cl. CPC H04R 3/04

(57) ABSTRACT

This document describes techniques and apparatuses directed at reducing intermodulation distortion effects in hearable devices. In aspects, an apparatus includes a first speaker and a second speaker disposed within a housing having an acoustic cavity adjacent to an aperture. The first speaker includes a first diaphragm facing the acoustic cavity and coupled to the housing by a forward roll surround. The second speaker includes a second diaphragm facing the acoustic cavity and coupled to the housing by a reverse roll surround. Intermodulation distortion effects that arise at the first diaphragm having the forward roll surround and the second diaphragm having the reverse roll surround are substantially offset by each other at the aperture.

### BACKGROUND

A diaphragm and a surround determine an effective radiation area of a speaker. The effective radiation diameter, which changes throughout an excursion cycle, determines a sound pressure level (SPL), or a loudness, of the speaker. The effective radiation diameter of a speaker including a forward roll surround, for example, is maximized when the diaphragm is positioned at a minimum excursion closest to a motor assembly and minimized when the diaphragm is positioned at a maximum excursion farthest from the motor assembly. Said differently, the speaker is loudest when the diaphragm is positioned at the minimum excursion and quietest when the diaphragm is positioned at the maximum excursion. This is not typically problematic for a speaker engineered for a specific frequency range, such as a subwoofer for low frequencies (e.g., 20 Hz to 2 kHz) or a tweeter for high frequencies (e.g., 2 kHz to 20 kHz). For such a speaker, the change in effective radiation diameter on each excursion cycle manifests as an asymmetric change in SPL, resulting in an even order harmonic distortion effect, which is often inoffensive to a listener. However, for a speaker engineered for a broader range of frequencies (e.g., a speaker for most frequencies audible to humans), offensive distortion effects can become apparent to a listener.

Distortion effects manifest in a full-range speaker when a low-frequency tone (e.g., bass) is radiated simultaneously with a high-frequency tone (e.g., treble). The motor assembly contemporaneously displaces the diaphragm in large increments (e.g., from the minimum excursion to the maximum excursion) to radiate the bass tone and in small increments (e.g., 10% of the minimum excursion to the maximum excursion) to radiate the treble tone. Therefore, using the example of the speaker including the forward roll surround above, the treble tone is loudest when the diaphragm is positioned near the minimum excursion and quietest when the diaphragm is positioned near the maximum excursion. This amplitude modulation of the treble tone is known as an intermodulation distortion (IMD) effect. IMD effects are especially problematic in speakers that consistently operate from the minimum excursion to the maximum excursion, such as micro-speakers (e.g., speakers having an effective radiation area of about 0.4 cm²) used in portable hearable devices (e.g., smartphones, headphones, earbuds).

### SUMMARY

This document describes techniques and apparatuses directed at reducing intermodulation distortion effects in hearable devices. In aspects, an apparatus includes a first speaker and a second speaker disposed within a housing having an acoustic cavity adjacent to an aperture. The first speaker includes a first diaphragm facing the acoustic cavity and coupled to the housing by a forward roll surround. The second speaker includes a second diaphragm facing the acoustic cavity and coupled to the housing by a reverse roll surround. Intermodulation distortion effects that arise at the first diaphragm having the forward roll surround and the second diaphragm having the reverse roll surround are substantially offset by each other at the aperture.

In aspects, an apparatus is disclosed that includes the following: a housing having at least one aperture; at least one acoustic cavity disposed within the housing, the at least one acoustic cavity adjacent to the at least one aperture; and first and second micro-speakers disposed within the housing. The first micro-speaker includes the following: a first frame coupled to the housing; a forward roll surround having a convex-shaped cross-section oriented convexly into the at least one acoustic cavity, the forward roll surround coupled to the first frame; a first diaphragm disposed about a first excursion axis, the first diaphragm facing inward toward the at least one acoustic cavity and coupled to the forward roll surround; and a first motor assembly disposed about the first excursion axis, the first motor assembly operably coupled to the first diaphragm and coupled to the first frame.

In aspects, the second micro-speaker includes the following: a second frame coupled to the housing; a reverse roll surround having a concave-shaped cross-section oriented concavely into the at least one acoustic cavity, the reverse roll surround coupled to the second frame; a second diaphragm disposed about a second excursion axis, the second diaphragm facing inward toward the at least one acoustic cavity and coupled to the reverse roll surround; and a second motor assembly disposed about the second excursion axis, the second motor assembly operably coupled to the second diaphragm and coupled to the second frame.

The details of one or more implementations are set forth in the accompanying Drawings and the following Detailed Description. Other features and advantages will be apparent from the Detailed Description, the Drawings, and the Claims. This Summary is provided to introduce subject matter that is further described in the Detailed Description. Accordingly, a reader should not consider the Summary to describe essential features or to limit the scope of the claimed subject matter.

### BRIEF DESCRIPTION OF THE DRAWINGS

Techniques and apparatuses directed at reducing intermodulation distortion effects in hearable devices are described in this document with reference to the following drawings, in which same numbers are used to reference like features and components:

FIG. 1 illustrates an example operating environment of a hearable device directed at reducing intermodulation distortion effects in hearable devices;

FIG. 2 illustrates an example implementation of a hearable device in accordance with one or more aspects;

FIG. 3A illustrates a top-down view of an example implementation of a micro-speaker in accordance with one or more aspects;

FIG. 3B illustrates a cross-section view of an example implementation of a motor assembly;

FIG. 3C illustrates a cross-section view of an example implementation of the motor assembly from FIG. 3B operably coupled to a diaphragm;

FIG. 4A illustrates a cross-section view of an example implementation of a first micro-speaker having a forward roll surround and a diaphragm positioned at a maximum excursion;

FIG. 4B illustrates a cross-section view of an example implementation of the first micro-speaker from FIG. 4A having the diaphragm positioned at a resting excursion;

FIG. 4C illustrates a cross-section view of an example implementation of the first micro-speaker from FIG. 4A having the diaphragm positioned at a minimum excursion;

FIG. 5A illustrates a cross-section view of an example implementation of a second micro-speaker having a reverse roll surround and a diaphragm positioned at a maximum excursion;

FIG. 5B illustrates a cross-section view of an example implementation of the second micro-speaker from FIG. 5A having the diaphragm positioned at a resting excursion;

FIG. 5C illustrates a cross-section view of an example implementation of the second micro-speaker from FIG. 5A having the diaphragm positioned at a minimum excursion;

FIG. 6 illustrates a cross-section view of an example implementation of an apparatus having a micro-speaker pair in accordance with one or more aspects;

FIG. 7A illustrates a cross-section view of the apparatus from FIG. 6B including rear volumes;

FIG. 7B illustrates a cross-section view of an example apparatus having a micro-speaker pair having coaxial excursion axes;

FIG. 7C illustrates a cross-section view of the apparatus from FIG. 7B including rear volumes;

FIG. 7D illustrates a cross-section view of another example apparatus having a micro-speaker pair having coaxial excursion axes;

FIG. 7E illustrates a cross-section view of the apparatus from FIG. 7D including a rear volume;

FIG. 7F illustrates a cross-section view of an example apparatus having a micro-speaker pair having non-coaxial excursion axes; and

FIG. 8 illustrates a method for reducing intermodulation distortion effects in hearable devices.

### DETAILED DESCRIPTION

### Overview

Many hearable devices (e.g., on-ear headphones, over-ear headphones, in-ear earbuds) include micro-speakers to afford portability to a user. Many computing devices (e.g., tablets, smartphones, laptops) include micro-speakers to enable a sleek or thin design that users find desirable. Micro-speakers may include any loudspeaker with an effective radiation area (effective radiation diameter) less than three square centimeters.

A diaphragm and a surround of a micro-speaker determine the effective radiation diameter. The diaphragm can be any one or a combination of a variety of materials (e.g., paper, plastic, laminate, metal), typically thin and rigid, and any one of a variety of three-dimensional shapes (e.g., flat, conic, hemispherical) and sizes. The surround can be a forward roll surround or a reverse roll surround and made from any one or a combination of a variety of materials (e.g., foam, resin-treated cloth, rubber, elastomeric compounds, flexible plastics) and can vary in size. The diaphragm is coupled to a frame or a housing of the micro-speaker via the surround. Further, the effective radiation area of the micro-speaker, which determines the micro-speaker's sound pressure level (SPL) (e.g., volume, loudness) changes as the diaphragm is displaced (e.g., by a motor assembly) along an excursion axis.

Notably, a shape of the surround changes during the displacement of the diaphragm along the excursion axis. A motor assembly may displace the diaphragm along the excursion axis to a maximum excursion farthest from the motor assembly and to a minimum excursion closest to the motor assembly. While the motor assembly does not exert a force on the diaphragm, the diaphragm is at a resting excursion. For example, a circular micro-speaker includes a forward roll surround that has an arc-shaped cross-section oriented convexly away from the motor assembly. A peak of the arc-shaped cross-section is closest to the diaphragm at the maximum excursion and farthest from the diaphragm at the minimum excursion. The effective radiation area of the micro-speaker may be approximated by a frontal area of a circle whose diameter is measured from peak to peak of the arc-shaped cross-section of the forward roll surround. Thus, at the maximum excursion, the effective radiation diameter of the micro-speaker is minimized, and at the minimum excursion, the effective radiation diameter of the micro-speaker is maximized. Continuing with the present example, assume the effective radiation area of the micro-speaker is 0.4 cm², the maximum excursion is 0.2 mm in a direction from the resting excursion, and the minimum excursion is 0.2 mm in an opposite direction from the resting excursion. In this example, the change in effective radiation area is approximately 10% per 0.4 mm (e.g., 25% per 1 mm). Said differently, the SPL, or volume, of the micro-speaker is 10% louder when the diaphragm is positioned at the minimum excursion versus the maximum excursion. As described, this change in effective radiation area versus diaphragm position is especially problematic in micro-speakers, which typically operate from the minimum excursion to the maximum excursion and radiate multiple frequencies (e.g., 20 Hz, 300 Hz, 2 kHz, 15 kHz) contemporaneously.

Although a circular micro-speaker including a circular effective radiation area is described herein, the micro-speaker and the effective radiation area can be any one of a variety of shapes. For example, the micro-speaker, components thereof (e.g., diaphragm, surround, frame), and the effective radiation area can be square with rounded corners, rectangular with rounded corners, capsule-shaped, ovular, and so forth. Accordingly, effective radiations areas for these various shapes may be approximated by respective frontal areas of a square, a rectangle, a capsule, an oval, and so forth.

Distortion effects manifest in a micro-speaker when a high-frequency tone (e.g., treble) is radiated on top of a low-frequency tone (e.g., bass). The motor assembly displaces the diaphragm in large increments (e.g., from the minimum excursion to the maximum excursion) to radiate the bass tone and simultaneously in small increments (e.g., 1% of the minimum excursion to the maximum excursion) to radiate the treble tone. Using the example of the micro-speaker including the forward roll surround and 0.4 cm2 effective radiation diameter above, the treble is loudest when the diaphragm is positioned near the minimum excursion and quietest when the diaphragm is positioned near the maximum excursion. This amplitude modulation of treble is known as an intermodulation distortion (IMD) effect, which, again, is especially problematic in micro-speakers that operate more consistently from the minimum excursion to the maximum excursion.

In contrast, consider the disclosed techniques and apparatuses directed at reducing IMD effects in hearable devices. The techniques and systems use a pair of micro-speakers having complementary surrounds. The pair of micro-speakers includes a first micro-speaker having a forward roll surround and a second micro-speaker having a reverse roll surround. IMD effects that arise at the forward roll surround and the reverse roll surround of the first and second micro-speakers, respectively, substantially offset each other.

This is one example of how the described techniques and apparatuses may be used to reduce IMD through paired micro-speakers having complementary, dissimilar surrounds. Other examples and implementations are described throughout this document. The document now turns to an example operating environment, after which example devices and systems are described.

### Operating Environment

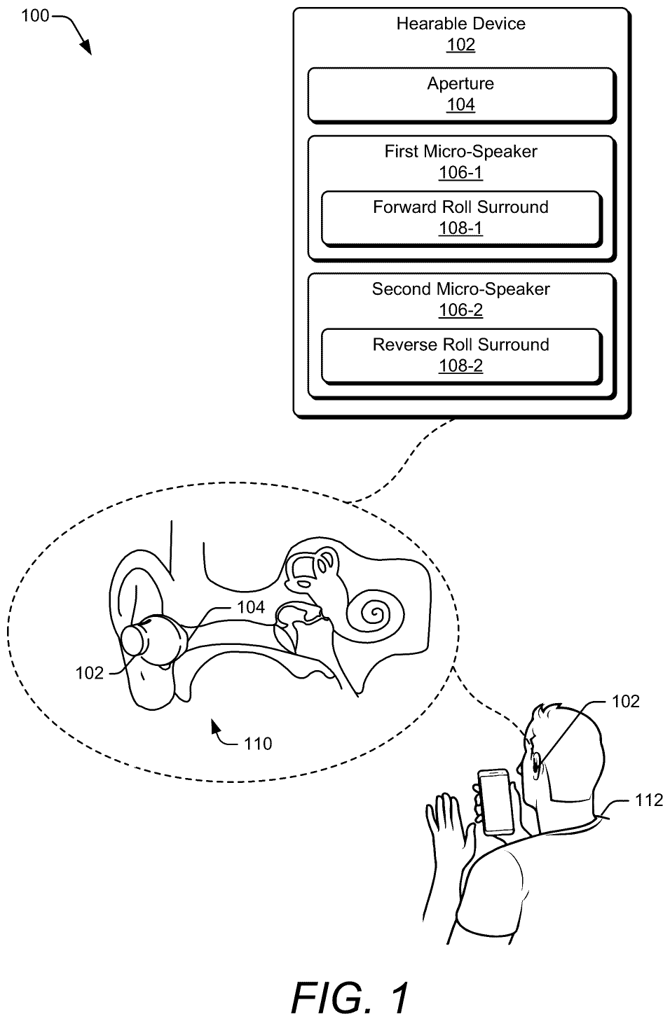

The following discussion describes an operating environment, techniques that may be employed in the operating environment, and various devices or systems in which components of the operating environment can be embodied. In the context of the present disclosure, reference is made to the operating environment by way of example only. In more detail, consider FIG. 1.

FIG. 1 illustrates, at 100 generally, an example operating environment of a hearable device 102 directed at reducing IMD effects in hearable devices. As illustrated in FIG. 1, the hearable device 102 includes an aperture 104, a first micro-speaker 106-1, and a second micro-speaker 106-2. In aspects, the first micro-speaker 106-1 and the second micro-speaker 106-2 are configured to face the aperture 104 so that separate audio signals from the micro-speakers 106 are combined to form a combined audio signal at the aperture 104. The first micro-speaker 106-1 includes a forward roll surround 108-1 and the second micro-speaker 106-2 includes a reverse roll surround 108-2. Thus, IMD effects that may arise in the separate audio signals of the first micro-speaker 106-1 and the second micro-speaker 106-2 substantially offset each other when combined into the combined audio signal at the aperture 104.

Further illustrated in FIG. 1 is an ear 110 of a user 112. As illustrated, the hearable device 102 fits snugly in the ear 110 of the user 112. The aperture 104 of the hearable device 102 is configured to direct the combined audio signal from the first micro-speaker 106-1 and the second micro-speaker 106-2 into the ear 110. Thus, because IMD effects that may arise in the separate audio signals of the micro-speakers 106 substantially offset each other when combined at the aperture 104, the user 112 enjoys audio with reduced IMD effects. This improves a user experience and satisfaction for the user 112.

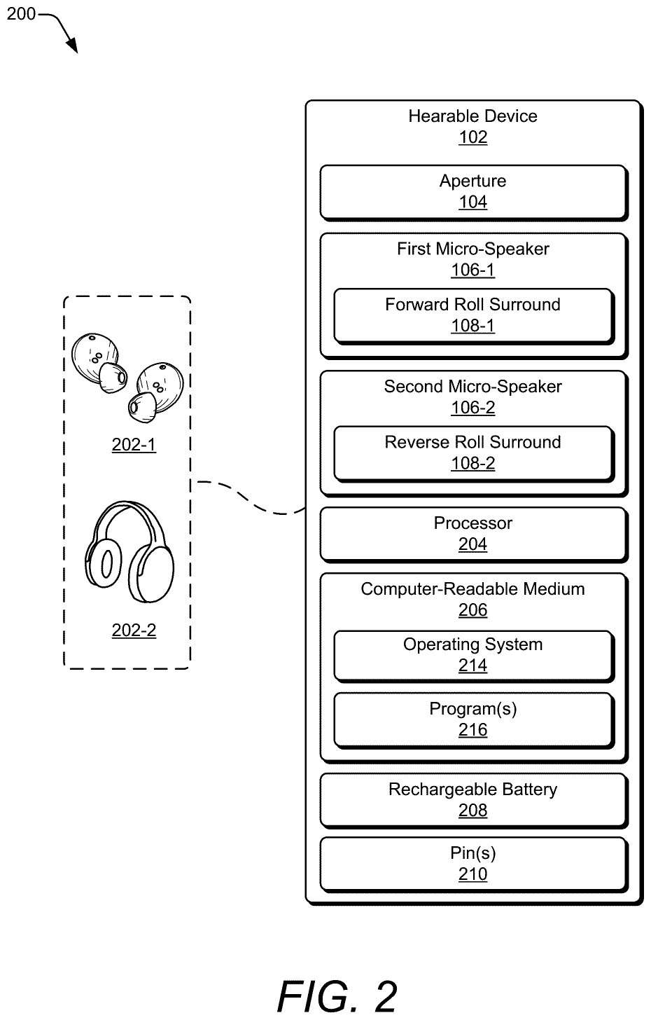

FIG. 2 illustrates, at 200 generally and in more detail, the example hearable device 102 from FIG. 1 in accordance with one or more aspects. The hearable device 102 is illustrated as various non-limiting example devices, including wireless earbuds 202-1 and wireless headphones 202-2. The wireless earbuds 202-1 are a type of in-ear device that fits into an ear canal, like the hearable device 102 illustrated in FIG. 1. Each wireless earbud 202-1 can represent a hearable device 102. The wireless headphones 202-2 can rest on top of the ears 110 (e.g., on-ear headphones) or over the ears 110 (e.g., over-ear headphones). Although wireless examples of the hearable device 102 are illustrated, the hearable device 102 can also be realized as wired examples.

As illustrated in FIG. 2, the hearable device 102 includes the first micro-speaker 106-1, the forward roll surround 108-1, the second micro-speaker 106-2, and the reverse roll surround 108-2 from FIG. 1. In general, the first and second micro-speakers 106 are directed towards the aperture 104, which is directed towards the ear (e.g., oriented towards an ear canal). The hearable device 102 further includes a processor 204, a computer-readable medium 206 (CRM 206), a rechargeable battery 208 (e.g., a battery pack), and one or more pins 210.

The processor 204 may include any appropriate processor, including, but not limited to, a central processing unit or a graphics processing unit. Although not illustrated, the CRM 206 can include one or more non-transitory storage media, such as memory media (e.g., dynamic random-access memory) and storage media (e.g., flash memory, a solid-state drive). Each of the non-transitory storage media included in the CRM 206 may be coupled with a respective data bus. The term “coupled” may refer to two or more elements that are in direct contact (e.g., physically, electrically, optically) or two or more elements that are not in direct contact with each other but still cooperate and interact with each other. The CRM 206 includes an operating system 214 (OS 214) and one or more programs 216. The OS 214 and the programs 216 may be stored as computer-readable instructions on the CRM 206. The processor 204 can execute the computer-readable instructions on the CRM 206 to provide functionalities of the OS 214, the programs 216, or both.

The rechargeable battery 208 may be realized as any suitable rechargeable battery. Although not illustrated, the rechargeable battery 208 may be a lithium-ion (Li-ion) rechargeable battery. Various Li-ion battery chemistries can be implemented, examples of which include lithium cobalt oxide, lithium iron phosphate, lithium manganese oxide, and lithium nickel manganese cobalt oxide. Further, the Li-ion rechargeable battery may include different anode materials, including graphite-based, silicon, graphene, and other suitable anode materials. The rechargeable battery 208 includes battery terminals for connection to a load (e.g., micro-speakers 106) and a charger. In wired implementations of the hearable device 102, the rechargeable battery 208 may not be included.

In implementations, the one or more pins 210 (e.g., electrical contacts) are flush with an exterior housing of the hearable device 102. For example, the one or more pins 210 are implemented as general-purpose input/output pins. In implementations, the battery terminals of the rechargeable battery 208 can be physically and electrically coupled to the one or more pins 210 (e.g., power supply pins). In this way, the one or more pins 210 may extend from the rechargeable battery 208 to an exterior surface of a housing of the hearable device 102 to receive electrical power from an external power supply. The one or more pins 210 may also be utilized for transferring data. In other implementations, the hearable device 102 can include a wireless charging circuit (e.g., an inductive charging circuit). The wireless charging circuit may be substituted for the one or more pins 210 or be included as a supplementary charging option. Additionally, or alternatively, the wireless charging circuit can enable other computing or electronic devices to charge the hearable device 102.

### Example Anatomies

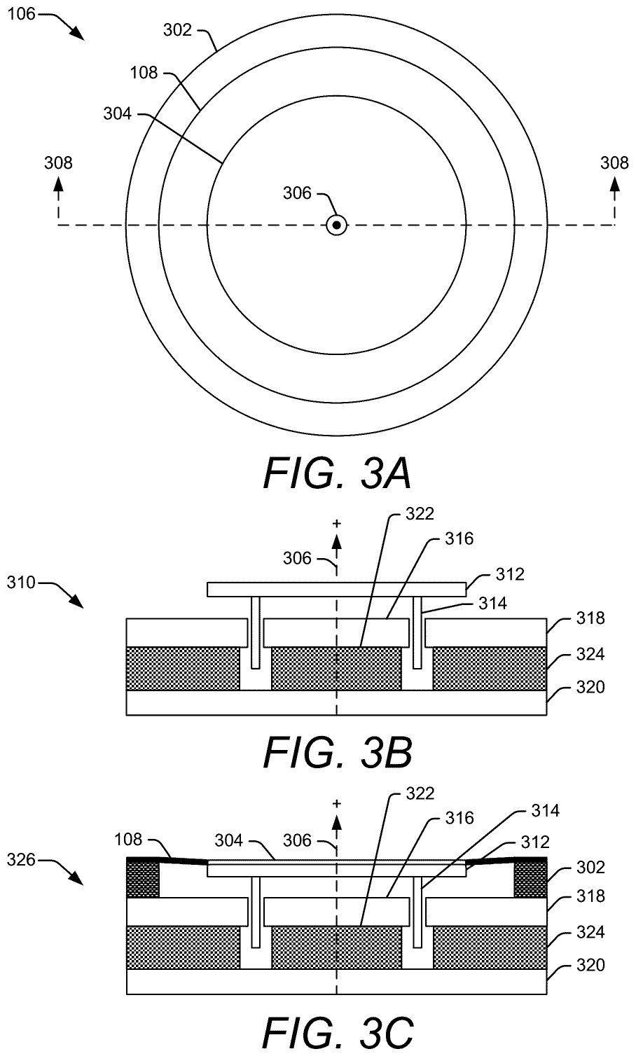

FIG. 3A illustrates a top-down view of an example implementation of a micro-speaker 106 in accordance with one or more aspects. As illustrated, the micro-speaker 106 includes a surround 108 (e.g., forward roll surround 108-1, reverse roll surround 108-2), a frame 302, and a diaphragm 304. The surround 108 is configured to couple the diaphragm 304 to the frame 302. The surround 108 can be realized as several three-dimensional shapes, including a forward roll surround, a reverse roll surround, a corrugated surround, a flat surround, and so forth. The surround 108 can be made from a variety of materials, including treated (e.g., resin-treated) cloth, foam (e.g., polyester), rubber, butylene compounds, and so forth.

A top surface of the diaphragm 304 is illustrated in FIG. 3A. The diaphragm 304, sometimes referred to as a “cone,” can be realized as various three-dimensional shapes, including a circular plane, a cone, a concave hemisphere, a convex hemisphere, and so forth. The diaphragm 304 may be made from any one of a variety of materials, which are typically lightweight, rigid, and non-resonant. These materials include, but are not limited to, ceramics, metals (e.g., titanium, aluminum), polypropylenes (e.g., injection molded polypropylene), and the like.

A top surface of the frame 302, sometimes referred to as a “basket,” is illustrated in FIG. 3A. The frame 302 can be realized as any one of a variety of three-dimensional shapes, including a basket, a cone, a hemisphere, a cuboid, and so forth. The frame 302 can be solid (e.g., no perforations or holes) or perforated (e.g., not solid) and made from various materials, including aluminum, steel, and plastics. The frame 302 is configured to support (e.g., physically) the diaphragm 304 by way of its coupling via the surround 108 to the diaphragm 304. Although not illustrated in FIG. 3A, a motor assembly may be disposed beneath the diaphragm 304.

Further illustrated in FIG. 3A is an excursion axis 306. The diaphragm 304, the frame 302, the surround 108 that couples the diaphragm 304 to the frame 302, and the motor assembly (not illustrated) are disposed about the excursion axis 306. The frame 302 and the surround 108 align the diaphragm 304 to the excursion axis 306 during operation of the micro-speaker 106 (e.g., as the motor assembly displaces the diaphragm 304 along the excursion axis 306). Additional components (e.g., a spider) (not illustrated) may also align the diaphragm 304 to the excursion axis 306 during operation of the micro-speaker 106. Also illustrated in FIG. 3A is a cross-sectional line 308, which is referenced in FIGS. 3B and 3C.

FIG. 3B illustrates a cross-section view along the cross-sectional line 308 of an example implementation of a motor assembly 310. Some components may be simplified or omitted from the illustration of the motor assembly 310 for clarity or brevity. As illustrated, the motor assembly 310 includes a dome 312 and a voice coil 314. The dome 312 is coupled (e.g., physically) to the voice coil 314. The voice coil 314 includes a coil of electrical conductors (e.g., wires) (not illustrated) disposed about the excursion axis 306, which includes a positive direction oriented away from a top surface of the dome 312. The electrical conductors may be self-supporting (e.g., via thermoset wire coatings), or wrapped around a plastic bobbin or other appropriate structural component, and can be any one of a variety of insulated electrical conductors, including solid copper wires and stranded copper wires. The electrical conductors of the voice coil 314 may receive electrical signals from a processor (e.g., the processor 204), a sound card, or an audio amplifier (e.g., a digital-to-analog converter) that represent audio signals. When the electrical signals pass through the voice coil 314, the voice coil 314 generates an electromagnetic field.

The motor assembly 310 further includes a front plate 316, a front ring 318, and a back plate 320. The front plate 316, the front ring 318, and the back plate 320 may sometimes be referred to as a “top plate,” a “pole piece,” and a “bottom plate,” respectively. The motor assembly 310 further includes a center magnet 322 and an outer magnet 324. The center magnet 322 and outer magnet 324 may be permanent magnets made from one of a variety of magnetic materials, including iron, iron oxide, iron oxide mixed with strontium (e.g., as powders mixed with a ceramic binder), and neodymium. The center magnet 322 is a polarity (e.g., north) and the outer magnet 324 is an opposite polarity (e.g., south) so that a magnetic field disposed about the excursion axis 306 is oriented radially (e.g., inwardly, outwardly). The electromagnetic field generated by the voice coil 314, together with the magnetic field generated by the center magnet 322 and the outer magnet 324, cause the voice coil 314 and the dome 312 to displace along the excursion axis 306.

FIG. 3C illustrates a cross-section view along the cross-sectional line 308 of an example implementation of the motor assembly 310 from FIG. 3B operably coupled to the diaphragm 304 from FIG. 3A. Depicted are components of the motor assembly 310 previously described with respect to FIG. 3B, including the dome 312, the voice coil 314, the front plate 316, the front ring 318, the back plate 320, the center magnet 322, and the outer magnet 324. FIG. 3C further illustrates the frame 302, the diaphragm 304, and a surround 108. Although the surround 108 is illustrated as a flat surround in FIG. 3C, it is provided as an example only. The surround 108 can be a forward roll surround (e.g., forward roll surround 108-1), a reverse roll surround (e.g., reverse roll surround 108-2), and so forth. The dome 312 is coupled to the diaphragm 304 by, for example, a press-fit interface or an adhesive. The diaphragm 304 is coupled to the surround 108, a flat surround in the present example, by a press-fit interface, an adhesive, or the like. The surround 108 is coupled to the frame 302.

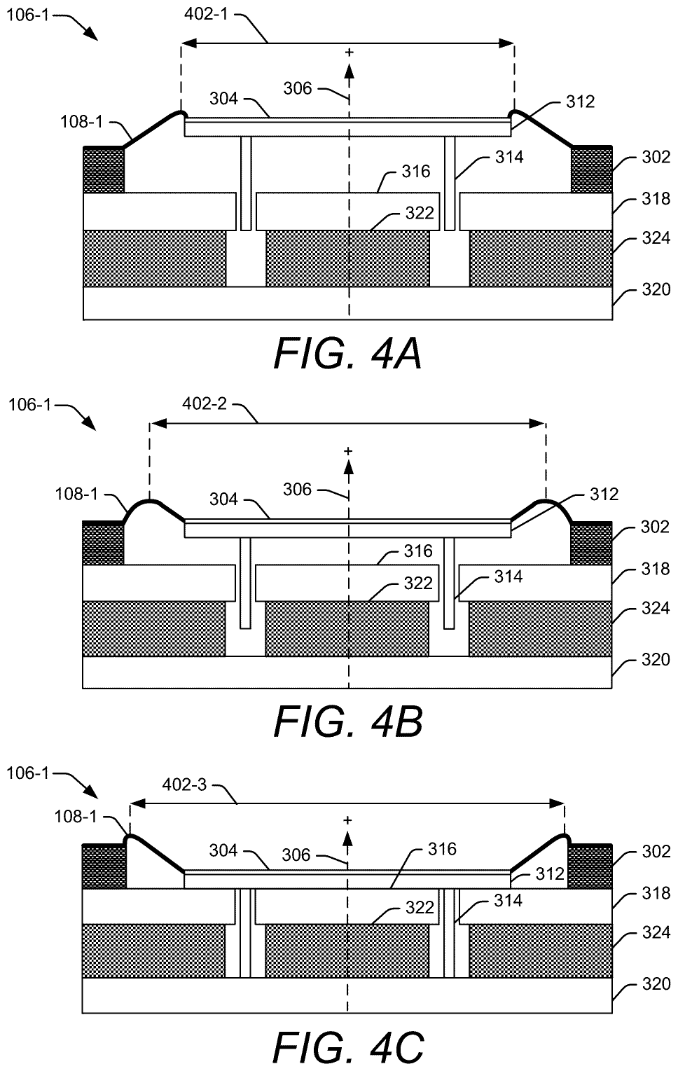

FIG. 4A illustrates a cross-section view of an example implementation of a first micro-speaker 106-1 having a forward roll surround 108-1 and a diaphragm 304 positioned at a maximum excursion. As illustrated, the first micro-speaker 106-1 includes the forward roll surround 108-1 coupled to the frame 302 and the diaphragm 304, both of which are disposed about the excursion axis 306, a positive direction of which is illustrated. The first micro-speaker 106-1 also includes the dome 312, the voice coil 314, the front plate 316, the front ring 318, the back plate 320, the center magnet 322, and the outer magnet 324 (e.g., the motor assembly 310), all disposed about the excursion axis 306.

As illustrated, the forward roll surround 108-1 has a convex-shaped cross-section oriented convexly toward the positive direction of the excursion axis 306. The convex-shaped cross-section is mirrored on a left side of the diaphragm 304 and a right side of the diaphragm 304. FIG. 4A further illustrates an effective radiation diameter 402-1 (D 402-1) of the first micro-speaker 106-1 when the diaphragm 304 is positioned at the maximum excursion. The D 402-1 is measured from a peak of the convex-shaped cross-section of the forward roll surround 108-1 on the left side of the diaphragm 304 to a peak of the arc-shaped cross-section of the forward roll surround 108-1 on the right side of the diaphragm 304. The peaks of the forward roll surround 108-1 on the left and right sides of the diaphragm 304 are closest to the diaphragm 304 at the maximum excursion. Accordingly, for the first micro-speaker 106-1 having the forward roll surround 108-1, the D 402-1 is smallest when the diaphragm 304 is positioned at the maximum excursion.

FIG. 4B illustrates a cross-section view of an example implementation of the first micro-speaker 106-1 from FIG. 4A having the diaphragm 304 positioned at a resting excursion. The first-micro-speaker 106-1 includes the forward roll surround 108-1, which is coupled to the frame 302 and the diaphragm 304. The forward roll surround 108-1, the frame 302, and the diaphragm 304 are disposed about the excursion axis 306, the positive direction of which is illustrated. The first micro-speaker 106-1 again includes the dome 312, the voice coil 314, the front plate 316, the front ring 318, the back plate 320, the center magnet 322, and the outer magnet 324 (e.g., the motor assembly 310), all disposed about the excursion axis 306.

As illustrated in FIG. 4B, the forward roll surround 108-1 has the convex-shaped cross-section oriented convexly toward the positive direction of the excursion axis 306. The convex-shaped cross-section is mirrored on the left side of the diaphragm 304 and the right side of the diaphragm 304. FIG. 4B also illustrates an effective radiation diameter 402-2 (D 402-2) of the first micro-speaker 106-1 when the diaphragm 304 is positioned at the resting excursion. The D 402-2 is measured from a peak of the convex-shaped cross-section of the forward roll surround 108-1 on the left side of the diaphragm 304 to a peak of the arc-shaped cross-section of the forward roll surround 108-1 on the right side of the diaphragm 304. The peaks of the forward roll surround 108-1 on the left and right sides of the diaphragm 304 are neither closest to nor farthest from the diaphragm 304 at the resting excursion. Thus, for the first micro-speaker 106-1 having the forward roll surround 108-1, the D 402-2 is neither the smallest nor the largest when the diaphragm 304 is positioned at the resting excursion.

FIG. 4C illustrates a cross-section view of an example implementation of the first micro-speaker 106-1 from FIG. 4A having the diaphragm 304 positioned at a minimum excursion. The first micro-speaker 106-1 includes the forward roll surround 108-1 coupled to the frame 302 and the diaphragm 304, all of which are disposed about the excursion axis 306, the positive direction of which is illustrated. The first micro-speaker 106-1 again includes the dome 312, the voice coil 314, the front plate 316, the front ring 318, the back plate 320, the center magnet 322, and the outer magnet 324 (e.g., the motor assembly 310), all disposed about the excursion axis 306.

As illustrated, the forward roll surround 108-1 has the convex-shaped cross-section oriented convexly toward the positive direction of the excursion axis 306. The convex-shaped cross-section is mirrored on the left side of the diaphragm 304 and the right side of the diaphragm 304. FIG. 4C also illustrates an effective radiation diameter 402-3 (D 402-3) of the first micro-speaker 106-1 when the diaphragm 304 is positioned at the minimum excursion. The D 402-3 is measured from a peak of the convex-shaped cross-section of the forward roll surround 108-1 on the left side of the diaphragm 304 to a peak of the arc-shaped cross-section of the forward roll surround 108-1 on the right side of the diaphragm 304. The peaks of the forward roll surround 108-1 on the left and right sides of the diaphragm 304 are farthest from the diaphragm 304 at the minimum excursion. Thus, for the first micro-speaker 106-1 having the forward roll surround 108-1, the D 402-3 is the largest when the diaphragm 304 is positioned at the minimum excursion.

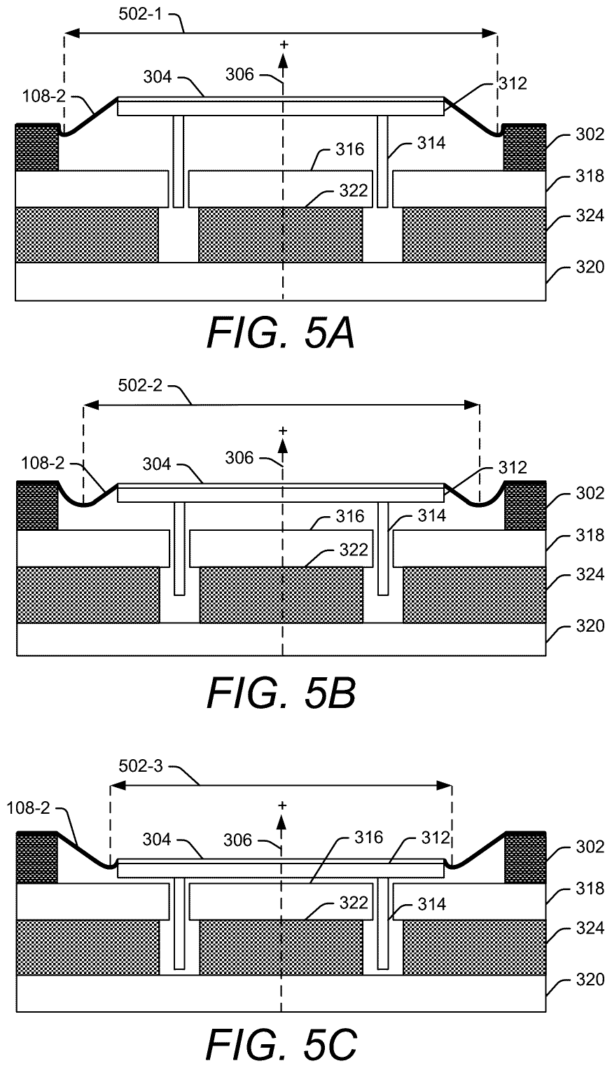

FIG. 5A illustrates a cross-section view of an example implementation of a second micro-speaker 106-2 having a reverse roll surround 108-2 and a diaphragm 304 positioned (e.g., by the motor assembly 310) at a maximum excursion. As illustrated, the second micro-speaker 106-2 includes the reverse roll surround 108-2 coupled to the frame 302 and the diaphragm 304, both of which are disposed about the excursion axis 306, a positive direction of which is illustrated. The second micro-speaker 106-2 also includes the dome 312, the voice coil 314, the front plate 316, the front ring 318, the back plate 320, the center magnet 322, and the outer magnet 324 (e.g., the motor assembly 310), all disposed about the excursion axis 306.

As illustrated, the reverse roll surround 108-2 has a concave-shaped cross-section oriented concavely toward the positive direction of the excursion axis 306. The concave-shaped cross-section is mirrored on a left side of the diaphragm 304 and a right side of the diaphragm 304. FIG. 5A further illustrates an effective radiation diameter 502-1 (D 502-1) of the second micro-speaker 106-2 when the diaphragm 304 is positioned at the maximum excursion. The D 502-1 is measured from a trough of the concave-shaped cross-section of the reverse roll surround 108-2 on the left side of the diaphragm 304 to a trough of the concave-shaped cross-section of the reverse roll surround 108-2 on the right side of the diaphragm 304. The troughs of the reverse roll surround 108-2 on the left and right sides of the diaphragm 304 are farthest from the diaphragm 304 at the maximum excursion. Accordingly, for the second micro-speaker 106-2 having the reverse roll surround 108-2, the D 502-1 is largest when the diaphragm 304 is positioned at the maximum excursion.

FIG. 5B illustrates a cross-section view of an example implementation of the second micro-speaker 106-2 from FIG. 5A having the diaphragm 304 positioned at a resting excursion. The second micro-speaker 106-2 includes the reverse roll surround 108-2, which is coupled to the frame 302 and the diaphragm 304. The reverse roll surround 108-2, the frame 302, and the diaphragm 304 are disposed about the excursion axis 306, the positive direction of which is illustrated. The second micro-speaker 106-2 again includes the dome 312, the voice coil 314, the front plate 316, the front ring 318, the back plate 320, the center magnet 322, and the outer magnet 324 (e.g., the motor assembly 310), all disposed about the excursion axis 306.

As illustrated in FIG. 5B, the reverse roll surround 108-2 has the concave-shaped cross-section oriented concavely toward the positive direction of the excursion axis 306. The convex-shaped cross-section is mirrored on the left side of the diaphragm 304 and the right side of the diaphragm 304. FIG. 5B also illustrates an effective radiation diameter 502-2 (D 502-2) of the second micro-speaker 106-2 when the diaphragm 304 is positioned at the resting excursion. The D 502-2 is measured from a trough of the concave-shaped cross-section of the reverse roll surround 108-2 on the left side of the diaphragm 304 to a trough of the arc-shaped cross-section of the reverse roll surround 108-2 on the right side of the diaphragm 304. The troughs of the reverse roll surround 108-2 on the left and right sides of the diaphragm 304 are neither closest to nor farthest from the diaphragm 304 at the resting excursion. Thus, for the second micro-speaker 106-2 having the reverse roll surround 108-2, the D 502-2 is neither the smallest nor the largest when the diaphragm 304 is positioned at the resting excursion.

FIG. 5C illustrates a cross-section view of an example implementation of the second micro-speaker 106-2 from FIG. 5A having the diaphragm 304 positioned at a minimum excursion. The second micro-speaker 106-2 includes the reverse roll surround 108-2, which is coupled to the frame 302 and the diaphragm 304. The reverse roll surround 108-2, the frame 302, and the diaphragm 304 are disposed about the excursion axis 306, the positive direction of which is illustrated. The second micro-speaker 106-2 again includes the dome 312, the voice coil 314, the front plate 316, the front ring 318, the back plate 320, the center magnet 322, and the outer magnet 324 (e.g., the motor assembly 310), all disposed about the excursion axis 306.

As illustrated, the reverse roll surround 108-2 has the concave-shaped cross-section oriented concavely toward the positive direction of the excursion axis 306. The concave-shaped cross-section is mirrored on the left side of the diaphragm 304 and the right side of the diaphragm 304. FIG. 5C also illustrates an effective radiation diameter 502-3 (D 502-3) of the second micro-speaker 106-2 when the diaphragm 304 is positioned at the minimum excursion. The D 502-3 is measured from a trough of the concave-shaped cross-section of the reverse roll surround 108-2 on the left side of the diaphragm 304 to a trough of the arc-shaped cross-section of the reverse roll surround 108-2 on the right side of the diaphragm 304. The troughs of the reverse roll surround 108-2 on the left and right sides of the diaphragm 304 are closest to the diaphragm 304 at the minimum excursion. Thus, for the second micro-speaker 106-2 having the reverse roll surround 108-2, the D 502-3 is the largest when the diaphragm 304 is positioned at the minimum excursion.

An effective radiation area of a micro-speaker (e.g., the first micro-speaker 106-1, the second micro-speaker 106-2) is proportional to the square of the effective radiation diameter (e.g., the D 402, the D 502). The effective radiation area (Sd) of the micro-speaker may be generally described by Equation 1.

$${S}_{d} = π * {( \frac{D}{2} )}^{2} \qquad ( 1 )$$

As illustrated in Equation 1, the effective radiation diameter is an area of a circle, a radius of which is one-half of the effective radiation diameter (e.g., the D 402, the D 502). In turn, an acoustic output of the micro-speaker is proportional to the square of the effective radiation diameter. The acoustic output (Aout) (e.g., volume, SPL) of the micro-speaker can be generally described by Equation 2.

$${A}_{out} = 1.18 * \frac{{S}_{d}^{2}}{2 π * 345 * {R}_{e}} * {( \frac{BL}{{M}_{m s}} )}^{2} \qquad ( 2 )$$

In addition to the effective radiation diameter of the micro-speaker, the acoustic output is a function of a resistance (Re) of the voice coil 314, a magnetic field (B) of the voice coil 314, a length (L) of the voice coil 314, and a moving mass (Mms) of the voice coil 314, the dome 312, the diaphragm 304, and the surround 108. The acoustic output is further a function of various constants (e.g., pi, 345). Notably, the acoustic output of the micro-speaker is proportional to the square of the effective radiation diameter. For simplicity, the constants in Equations 1 and 2 can be removed to yield Equations 3 and 4, respectively.

$${S}_{d} ∝ {D}^{2} \qquad ( 3 )$$

$${A}_{out} ∝ {S}_{d}^{2} \qquad ( 4 )$$

For further simplicity, Equation 3 can be substituted for the effective radiation diameter in Equation 4 to yield Equation 5.

$${A}_{out} ∝ {D}^{4} \qquad ( 5 )$$

As illustrated, the acoustic output of a micro-speaker is proportional to the fourth power of the effective radiation diameter. As an example, the D 402-2 and the D 502-2 of the first micro-speaker 106-1 and the second micro-speaker 106-2, respectively, are a same effective radiation diameter when the diaphragm 304 is positioned at the resting excursion. When the diaphragm 304 is positioned at the resting excursion, the D 402-2 and the D 502-2 can be expressed as a normalized value of one (1.0), or 100%. Continuing with the present example, the effective radiation areas of the first micro-speaker 106-1 and the second micro-speaker 106-2 change by 0.1 (or 10%) when the diaphragm 304 is moved from the resting excursion to either the minimum excursion or the maximum excursion. Using Equation 5 and when the diaphragm is positioned at the resting excursion, the acoustic output of the first micro-speaker 106-1 and the second micro-speaker 106-2 is proportional to 1.0.

As the diaphragm 304 of the first micro-speaker 106-1 is displaced from the resting excursion to the maximum excursion (e.g., from FIG. 4B to FIG. 4A), the effective radiation diameter decreases by 0.1 from 1.0 to 0.9 (e.g., D 402-1 is equal to 0.9). Using Equation 5, the acoustic output of the first micro-speaker decreases from being proportional to 1.0 to being proportional to 0.66. As the diaphragm 304 is displaced from the resting excursion to the minimum excursion (e.g., from FIG. 4B to FIG. 4C), the effective radiation diameter increases by 0.1 from 1.0 to 1.1 (e.g., D 402-3 is equal to 1.1). This means that the acoustic output of the first micro-speaker 106-1 increases from being proportional to 1.0 to being proportional to 1.46.

As for the second micro-speaker 106-2 having the reverse roll surround 108-2, as the diaphragm 304 is displaced from the resting excursion to the maximum excursion (e.g., from FIG. 5B to FIG. 5A), the effective radiation diameter increases by 0.1 from 1.0 to 1.1 (e.g., D 502-1 is equal to 1.1). Using Equation 5, the acoustic output of the second micro-speaker increases from being proportional to 1.0 to being proportional to 1.46. As the diaphragm 304 is displaced from the resting excursion to the minimum excursion (e.g., from FIG. 5B to FIG. 5C), the effective radiation diameter decreases by 0.1 from 1.0 to 0.9 (e.g., D 502-3 is equal to 0.9). Using Equation 5, this means that the acoustic output of the second micro-speaker 106-2 decreases from being proportional to 1.0 to being proportional to 0.66. Notably, the acoustic output of the first micro-speaker 106-1 and the acoustic output of the second micro-speaker 106-2 are inversely proportional to a displacement of the diaphragm 304.

As described herein, the acoustic output of the first micro-speaker 106-1 having the forward roll surround 108-1 increases as the diaphragm 304 is displaced from the maximum excursion to the minimum excursion. Similarly, but oppositely, the acoustic output of the second micro-speaker 106-2 having the reverse roll surround 108-2 decreases as the diaphragm 304 is displaced from the maximum excursion to the minimum excursion. As an example, the effective radiation diameters D 402-2 and D 502-2 of the first micro-speaker 106-1 and the second micro-speaker 106-2, respectively, are equal to a same diameter of 4.8 mm when the diaphragm is positioned at the resting excursion. The D 402-1 and the D 502-3 are equal to a same diameter of 4.5 mm, for example, when the diaphragm 304 of the first micro-speaker 106-1 is positioned at the maximum excursion and the diaphragm 304 of the second micro-speaker 106-2 is positioned at the minimum excursion, respectively. The D 402-3 and the D 502-1 of the first micro-speaker 106-1 and the second micro-speaker 106-2, respectively, are equal to a same diameter of 5.1 mm when the diaphragm 304 is positioned at the minimum excursion and the maximum excursion. Although effective radiation diameters of 4.5 mm, 4.8 mm, and 5.1 mm are described, the diameter can be any length (e.g., 4.0 mm, 5.0 mm, 6.0 mm, 6.2 mm). The document now turns to example apparatuses directed at reducing IMD effects in hearable devices that utilize both a micro-speaker having a forward roll surround (e.g., the first micro-speaker 106-1) and a micro-speaker having a reverse roll surround (e.g., the second micro-speaker 106-2).

### Example Apparatuses

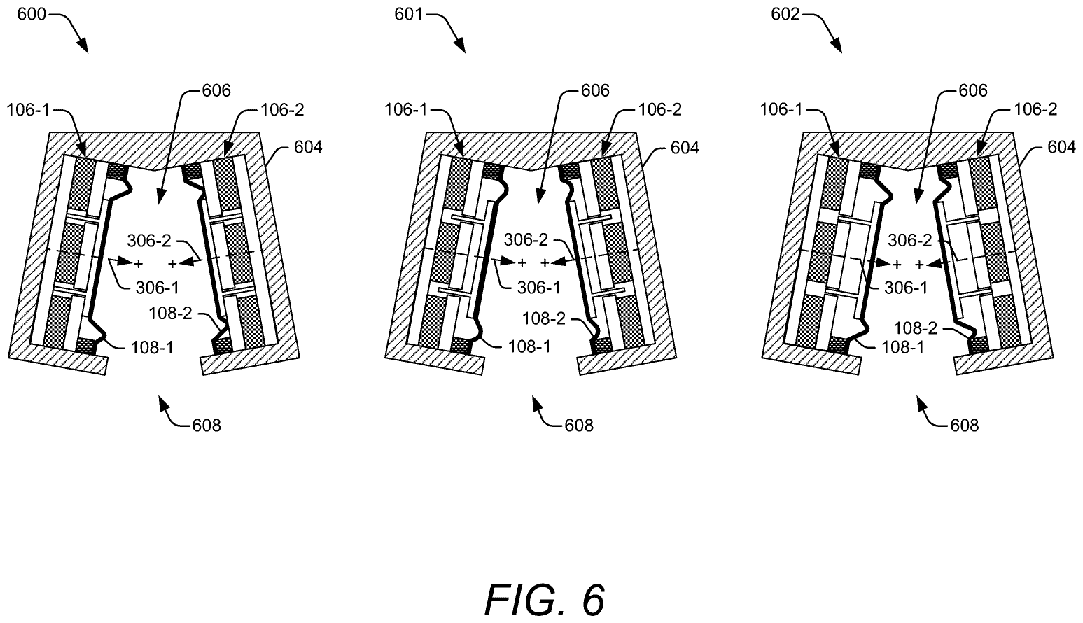

FIG. 6 illustrates a cross-section view of an example implementation of an apparatus having a micro-speaker pair in accordance with one or more aspects. In this implementation, the micro-speaker pair includes the first micro-speaker 106-1 and the second micro-speaker 106-2 from FIGS. 1 and 4A through 5C, each of which includes a motor assembly (e.g., motor assembly 310), a frame (e.g., frame 302), a diaphragm (e.g., diaphragm 304), and a surround (e.g., forward roll surround 108-1, reverse roll surround 108-2). In FIG. 6, some components of the first micro-speaker 106-1 and the second micro-speaker 106-2 are not labeled for the sake of clarity.

As illustrated, the apparatus includes a housing 604, an acoustic cavity 606, and an aperture 608. The housing 604 can be comprised of any appropriate material (e.g., plastic, wood, metal) and can be any one of a variety of shapes (e.g., cuboid, sphere). In this implementation, the shape is trapezoidal and the acoustic cavity 606 is disposed within the housing 604 adjacent to the aperture 608, which is disposed on a bottom side of the housing 604.

As illustrated, the forward roll surround 108-1 of the first micro-speaker 106-1 includes a convex-shaped cross-section oriented convexly into the acoustic cavity 606. The reverse roll surround 108-2 of the second micro-speaker 106-2 includes a concave-shaped cross-section oriented concavely into the acoustic cavity 606. In the current implementation, the first micro-speaker 106-1 is disposed on a left side within the housing 604 and the second micro-speaker 106-2 is disposed on a right side within the housing 604. However, the first micro-speaker 106-1 and the second micro-speaker 106-2 can be disposed anywhere within the housing.

FIG. 6 further illustrates that the diaphragms of the first micro-speaker 106-1 and the second micro-speaker 106-2 are displaced along a first excursion axis 306-1 and a second excursion axis 306-2, respectively, that are not coaxial. The first excursion axis 306-1 includes a positive direction oriented towards the second micro-speaker 106-2, and the second excursion axis 306-2 includes a positive direction oriented towards the first micro-speaker 106-1. At 600, the apparatus is illustrated as having the diaphragms (e.g., diaphragms 304) of the first micro-speaker 106-1 and the second micro-speaker 106-2 positioned at the minimum excursion. At 601, the diaphragms are positioned at the resting excursion, and at 602, the diaphragms are positioned at the maximum excursion. Notably, the diaphragms of the first micro-speaker 106-1 and the second micro-speaker 106-2 are displaced in the positive directions of the first excursion axis 306-1 and the second excursion axis 306-2, respectively and contemporaneously. By so doing, IMD effects that arise at the forward roll surround 108-1 of the first micro-speaker 106-1 and the reverse roll surround 108-2 of the second micro-speaker 106-2 substantially offset each other.

For example, referring to FIGS. 4A through 5C and Equations 1 through 5, the first micro-speaker 106-1 having the forward roll surround 108-1 and the second micro-speaker 106-2 having the reverse roll surround 108-2 include complementary acoustic outputs. At the maximum excursion (view 602), as described herein, the acoustic output of the first micro-speaker is proportional to 0.66 and the acoustic output of the second micro-speaker 106-2 is proportional to 1.46. At the resting excursion (view 601), both the acoustic output of the first micro-speaker 106-1 and the acoustic output of the second micro-speaker 106-2 are proportional to 1.0. At the minimum excursion (view 600), the acoustic output of the first micro-speaker 106-1 is proportional to 1.46 and the acoustic output of the second micro-speaker 106-2 is proportional to 0.66.

A combined acoustic output at the aperture 608, because both micro-speakers 106 face the acoustic cavity 606 adjacent to the aperture 608, can be calculated for each of the three diaphragm positions illustrated in FIG. 6. At view 600 (the minimum excursion), the combined acoustic output of the first micro-speaker 106-1 and the second micro-speaker 106-2 is 2.12. At view 601 (the resting excursion), the combined acoustic output of the first and second micro-speakers 106 is 2.0. At view 602 (the maximum excursion), the combined acoustic output of the first and second micro-speakers 106 is 2.12. Thus, IMD effects that arise at the diaphragms (e.g., diaphragms 304) of the first micro-speaker 106-1 having the forward roll surround 108-1 and the second micro-speaker 106-2 having the reverse roll surround 108-2 substantially offset each other at the aperture 608.

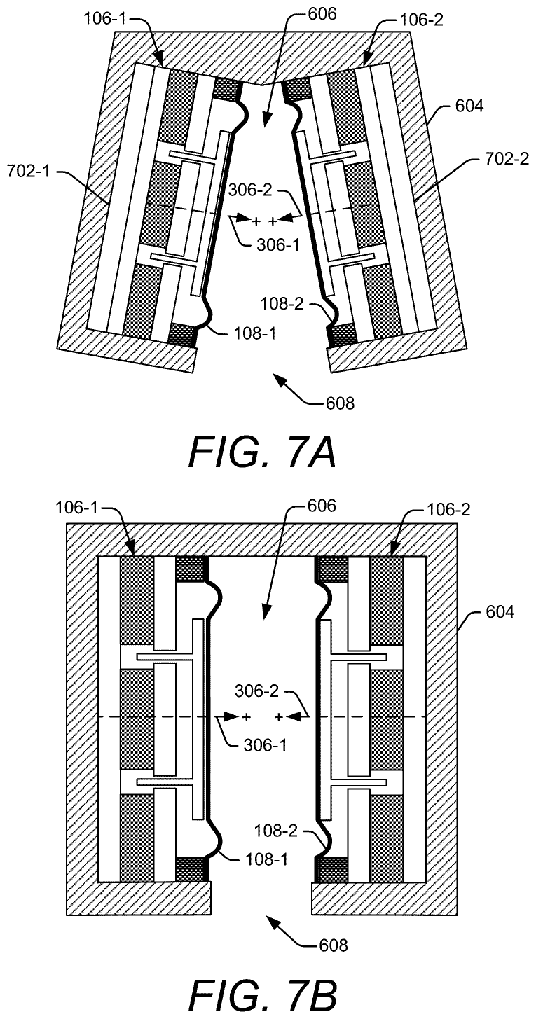

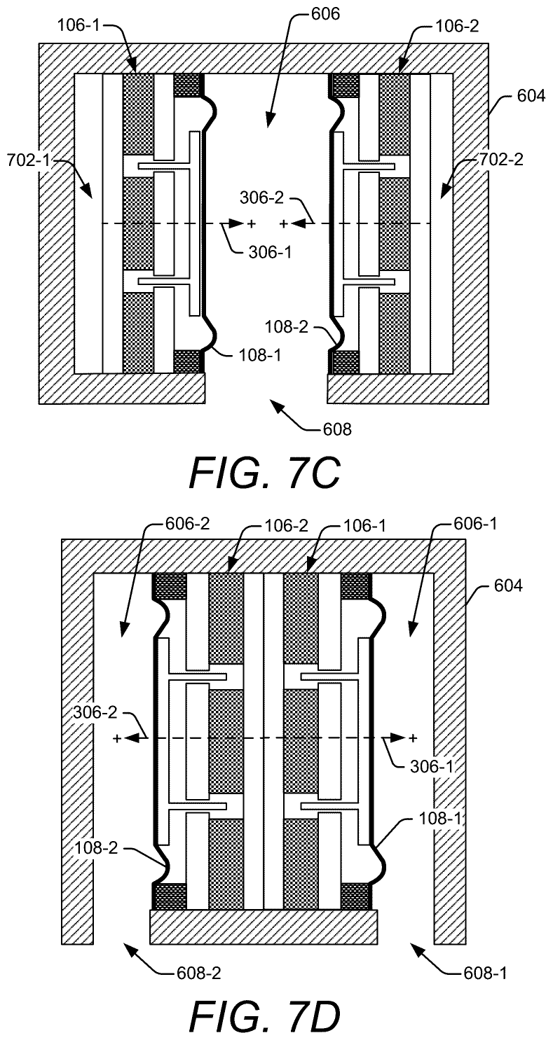

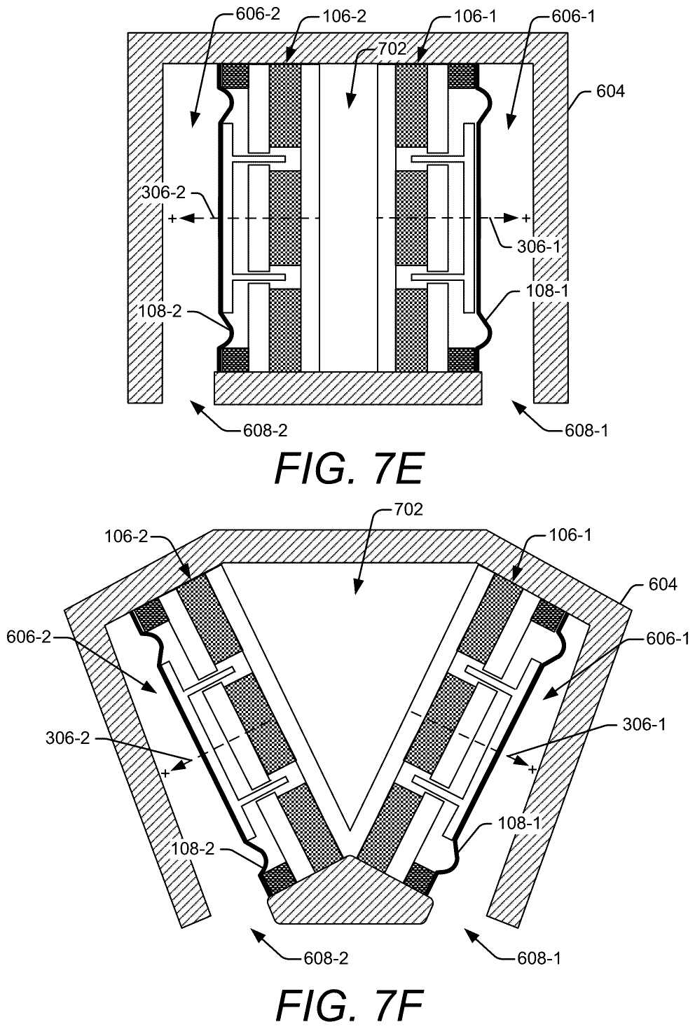

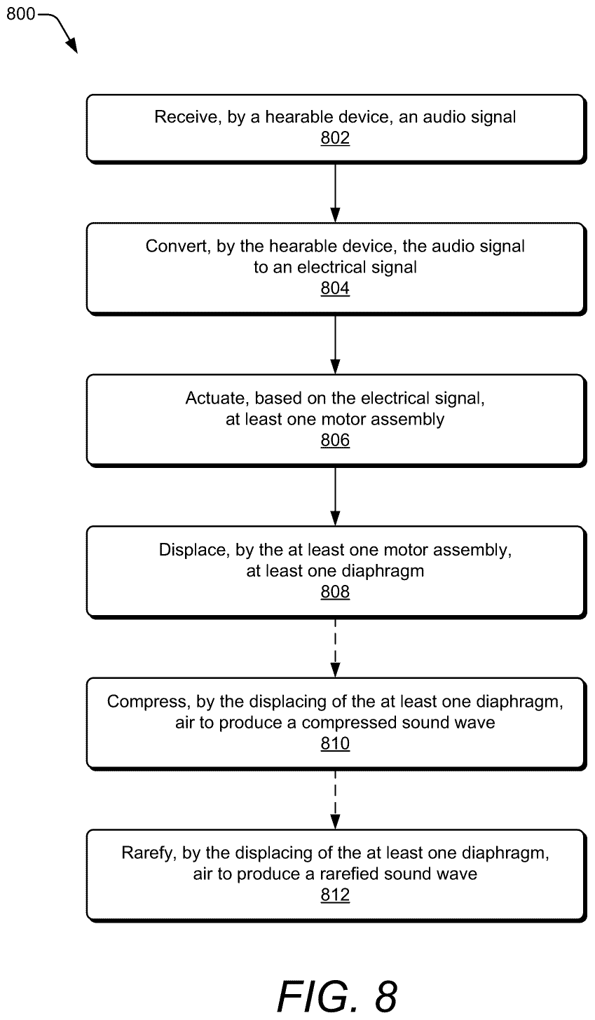

FIGS. 7A through 7F illustrate various alternative implementations of an apparatus having a micro-speaker pair. FIG. 7A illustrates a cross-section view of the apparatus from FIG. 6B including rear volumes 702. As illustrated, the apparatus includes the first micro-speaker 106-1, the forward roll surround 108-1, the second micro-speaker 106-2, and the reverse roll surround 108-2. The apparatus further includes the first excursion axis 306-1 and the second excursion axis 306-2, which are not coaxial. Both excursion axes 306 include positive directions oriented towards each other. The apparatus also includes the housing 604, the acoustic cavity 606 disposed within the housing 604, and the aperture 608. The acoustic cavity 606 is disposed adjacent to the aperture 608.

In this implementation, the apparatus further includes rear volumes 702. A first rear volume 702-1 is disposed between the housing 604 and the first micro-speaker 106-1. A second rear volume 702-2 is disposed between the housing 604 and the second micro-speaker 106-2. The rear volumes 702 can be included to improve a low-frequency (e.g., bass tone) response of the micro-speakers 106. The rear volumes 702 may be enclosed (as shown) or vented (e.g., by additional apertures 608 in the housing 604) (not shown) and sometimes referred to as a ported box, vented box, or reflex port.

FIG. 7B illustrates a cross-section view of an example apparatus having a micro-speaker pair having coaxial excursion axes 306. As illustrated, the apparatus includes the first micro-speaker 106-1, the forward roll surround 108-1, the second micro-speaker 106-2, and the reverse roll surround 108-2. The first micro-speaker 106-1 is disposed on a left side within the housing 604, and the second micro-speaker 106-2 is disposed on a right side within the housing 604. Both micro-speakers 106 are oriented towards the acoustic cavity 606, which is disposed within the housing 604 and adjacent to the aperture 608. In this implementation, the first excursion axis 306-1 and the second excursion axis 306-2 are coaxial. As illustrated in FIG. 7B, the excursion axes 306 include positive directions oriented towards each other.

FIG. 7C illustrates a cross-section view of the apparatus from FIG. 7B including the rear volumes 702. As illustrated, the apparatus includes the first micro-speaker 106-1, the forward roll surround 108-1, the second micro-speaker 106-2, and the reverse roll surround 108-2. The first micro-speaker 106-1 is disposed on a left side within the housing 604 and the second micro-speaker 106-2 is disposed on a right side within the housing 604. Both micro-speakers 106 are oriented towards the acoustic cavity 606, which is disposed within the housing 604 and adjacent to the aperture 608. The first excursion axis 306-1 and the second excursion axis 306-2 are coaxial and include positive directions oriented towards each other. In this implementation, the rear volumes 702 are disposed within the housing 604. The first rear volume 702-1 is disposed between the housing 604 and the first micro-speaker 106-1. The second rear volume 702-2 is disposed between the housing 604 and the second micro-speaker 106-2.

For the implementations described with respect to FIGS. 7A through 7C, the first micro-speaker 106-1 includes the forward roll surround 108-1 and the second micro-speaker 106-2 includes the reverse roll surround 108-2. As described with reference to FIGS. 4A through 6, the forward roll surround 108-1 and the reverse roll surround 108-2 exhibit complementary, but dissimilar, acoustic outputs throughout an excursion cycle. Additionally, because both micro-speakers 106 are oriented towards the acoustic cavity 606, which is adjacent to the aperture 608, IMD effects that arise at the first and second micro-speakers 106 are reduced at the aperture 608.

FIG. 7D illustrates a cross-section view of another example apparatus having a micro-speaker pair having coaxial excursion axes 306. As illustrated, the apparatus includes the first micro-speaker 106-1, the forward roll surround 108-1, the second micro-speaker 106-2, and the reverse roll surround 108-2. In this implementation, the first micro-speaker 106-1 is disposed on a right side within the housing 604 and the second micro-speaker 106-2 is disposed on a left side within the housing 604.

Rather than a single acoustic cavity 606, this implementation includes a first acoustic cavity 606-1 and a second acoustic cavity 606-2. Additionally, this implementation includes a first aperture 608-1 and a second aperture 608-2. The first acoustic cavity 606-1 is disposed within the housing 604 and adjacent to the first aperture 608-1. The second acoustic cavity 606-2 is disposed within the housing 604 and adjacent to the second aperture 608-2. The first micro-speaker 106-1 is oriented towards the first acoustic cavity 606-1, and the second micro-speaker 106-2 is oriented towards the second acoustic cavity 606-2.

Further, as illustrated in FIG. 7D, the first micro-speaker 106-1 is disposed about a first excursion axis 306-1, a positive direction of which is oriented towards the right side of the housing 604. The second micro-speaker 106-2 is disposed about a second excursion axis 306-2, a positive direction of which is oriented towards the left side of the housing 604. As illustrated, the positive directions of the excursion axes 306 are oriented away from each other and towards respective acoustic cavities 606.

FIG. 7E illustrates a cross-section view of the apparatus from FIG. 7D including a rear volume 702. As illustrated, the apparatus includes the first micro-speaker 106-1 disposed on a right side within the housing and about the first excursion axis 306-1. The first excursion axis 306-1 includes a positive direction oriented towards the right side of the housing 604. The apparatus also includes the second micro-speaker 106-2 disposed on a left side within the housing 604 and about the second excursion axis 306-2. The second excursion axis 306-2 includes a positive direction oriented towards the left side of the housing 604. The first and second excursion axes 306 are coaxial in this implementation. The first micro-speaker 106-1 includes the forward roll surround 108-1 and is oriented towards the first acoustic cavity 606-1, which is adjacent to the first aperture 608-1. The second micro-speaker 106-2 includes the reverse roll surround 108-2 and is oriented towards the second acoustic cavity 606-2 adjacent to the second aperture 608-2.

In this implementation, the apparatus further includes the rear volume 702, which can be configured to improve low-frequency responses of the micro-speakers 106. The rear volume can, additionally or alternatively, be configured to increase acoustic efficiencies of the micro-speakers 106. The rear volume 702 can be enclosed (as shown) or vented (not shown) (e.g., by additional apertures 608).

FIG. 7F illustrates a cross-section view of an example apparatus having a micro-speaker pair having non-coaxial excursion axes 306. As illustrated, the apparatus includes the first micro-speaker 106-1, the forward roll surround 108-1, the second micro-speaker 106-2, and the reverse roll surround 108-2. The apparatus further includes the first excursion axis 306-1 and the second excursion axis 306-2, which are not coaxial. Both excursion axes 306 include positive directions oriented away from each other. The apparatus further includes a rear volume 702 disposed within the housing 604 and between the first and second micro-speakers 106. The rear volume 702 can be fully enclosed (as shown) or vented (not shown).

In this implementation, the apparatus includes a first acoustic cavity 606-1 disposed within the housing 604 and adjacent to a first aperture 608-1 on a right side of the housing 604. The apparatus includes a second acoustic cavity 606-2 disposed within the housing 604 and adjacent to a second aperture 608-2 on a left side of the housing 604. The first micro-speaker 106-1 including the forward roll surround 108-1 is oriented towards the first acoustic cavity 606-1 on the right side of the housing 604. The second micro-speaker 106-2 including the reverse roll surround 108-2 is oriented towards the second acoustic cavity 606-2 on the left side of the housing 604.

For the implementations described with respect to FIGS. 7D through 7F, the first micro-speaker 106-1 includes the forward roll surround 108-1 and the second micro-speaker 106-2 includes the reverse roll surround 108-2. The forward roll surround 108-1 and the reverse roll surround 108-2 exhibit complementary, but dissimilar, acoustic outputs throughout an excursion cycle as described with reference to FIGS. 4A through 6.

In these implementations, IMD effects that arise at the first micro-speaker 106-1 including the forward roll surround 108-1 are present at the first aperture 608-1. Additionally, IMD effects that arise at the second micro-speaker 106-2 including the reverse roll surround 108-2 are present at the second aperture 608-2. However, at a distance (e.g., 4 mm, 1 cm, 1.5 cm, etc.) outside of the housing 604, the acoustic outputs of the micro-speakers 106 may combine, substantially offsetting the IMD effects present at the first and second apertures 608.

### Example Methods

FIG. 8 illustrates a method 800 for reducing intermodulation distortion effects in hearable devices. The method 800 may be performed by a hearable device or a processor thereof. At 802, the hearable device receives an audio signal. The audio signal can be a digital audio signal or an analog audio signal. The audio signal may include volume information (e.g., amplitude information) and tone information (e.g., frequency information). The audio signal may be an electrical signal, an optical signal, an electromagnetic signal (e.g., Bluetooth, Wi-Fi), and so forth.

At 804, the hearable device converts the audio signal to an electrical signal. If the audio signal is, as described herein, already an electrical signal, the conversion may include a boosting of the amplitude of the audio signal. If the audio signal is compressed air (e.g., sound waves, an acoustic signal), the conversion may include a converting of the audio signal into an electrical signal by an audio transducer (e.g., a microphone). If the audio signal is an electromagnetic signal, such as a Bluetooth signal, the conversion may include a converting of the audio signal into an electrical signal by a transceiver (e.g., a cellular radio, a Bluetooth radio). The electrical signal includes a voltage, a current, and a frequency that corresponds to the audio information contained in the audio signal.

At 806, the hearable device actuates, based on the electrical signal, at least one motor assembly (e.g., motor assembly 310). The actuation can include directing the electrical current through a voice coil (e.g., voice coil 314) of the motor assembly. The voice coil may produce an electromagnetic field that interacts with a magnetic field of a permanent magnet (e.g., center magnet 322, outer magnet 324) included in the motor assembly to produce an electromagnetic force.

At 808, the hearable device displaces, by the at least one motor assembly, at least one diaphragm (e.g., diaphragm 304). The motor assembly may be coupled to the at least one diaphragm and displace the at least one diaphragm via the electromagnetic force described herein. At 810, the hearable device compresses, by the displacing of the diaphragm, air to produce a compressed sound wave. Alternatively, at 812, the hearable device rarefies, by the displacing of the diaphragm, air to produce a rarefied sound wave. The compressing and rarefying of air to produce compressed and rarefied sound waves, respectively, may occur repeatedly at various frequencies and amplitudes (e.g., smaller displacements, larger displacements) to produce different tones (e.g., bass tones, mid tones, treble tones). By so doing, the hearable device may reproduce a variety of recorded sounds (e.g., voices, instruments, vehicles), for example.

In an implementation, the at least one motor assembly includes first and second motor assemblies, and the at least one diaphragm includes first and second diaphragms. The first motor assembly may be coupled to the first diaphragm (e.g., as in the first micro-speaker 106-1) and the second motor assembly may be coupled to the second diaphragm (e.g., as in the second micro-speaker 106-2). Accordingly, the compressing of air includes contemporaneously compressing air by the first diaphragm and the second diaphragm to produce first and second compressed sound waves, respectively. Similarly, the rarefying of air includes contemporaneously rarefying air by the first and second diaphragms to produce first and second rarefied sound waves.

In another implementation, the hearable device may combine the first and second compressed sound waves into a combined compressed sound wave. Similarly, the hearable device may combine the first and second rarefied sound waves to produce a combined rarefied sound wave. The hearable device may combine the first and second compressed or rarefied sound waves by directing them toward at least one acoustic cavity (e.g., acoustic cavity 606) adjacent to at least one aperture (e.g., aperture 608). The acoustic cavity and the aperture may be included in a housing (e.g., housing 604) of the hearable device. In this implementation, the first diaphragm may be coupled to the housing by a forward roll surround (e.g., forward roll surround 108-1) and the second diaphragm may be coupled to the housing by a reverse roll surround (e.g., reverse roll surround 108-2). By so doing, intermodulation distortion effects that arise at the first and second diaphragms may, when the first and second sound waves are combined by the hearable device, substantially offset each other at the aperture.

### ADDITIONAL EXAMPLES

In the following section, examples are provided.

Example 1: An apparatus comprising: a housing having at least one aperture; at least one acoustic cavity disposed within the housing, the at least one acoustic cavity adjacent to the at least one aperture; a first micro-speaker disposed within the housing, the first micro-speaker comprising: a first frame coupled to the housing; a forward roll surround having a convex-shaped cross-section oriented convexly into the at least one acoustic cavity, the forward roll surround coupled to the first frame; a first diaphragm disposed about a first excursion axis, the first diaphragm facing the at least one acoustic cavity and coupled to the forward roll surround; and a first motor assembly disposed about the first excursion axis and operably coupled to the first diaphragm; and a second micro-speaker disposed within the housing, the second micro-speaker comprising: a second frame coupled to the housing; a reverse roll surround having a concave-shaped cross-section oriented concavely into the at least one acoustic cavity, the reverse roll surround coupled to the second frame; a second diaphragm disposed about a second excursion axis, the second diaphragm facing the at least one acoustic cavity and coupled to the reverse roll surround; and a second motor assembly disposed about the second excursion axis and operably coupled to the second diaphragm.

Example 2: The apparatus of example 1, wherein the first excursion axis and the second excursion axis are not coaxial.

Example 3: The apparatus of example 1, wherein the first excursion axis and the second excursion axis are coaxial.

Example 4: The apparatus of example 1, wherein: the first motor assembly displaces the first diaphragm in a first positive direction oriented away from the first motor assembly and towards the second diaphragm; and the second motor assembly displaces the second diaphragm in a second positive direction oriented away from the second motor assembly and towards the first diaphragm.

Example 5: The apparatus of example 1, wherein: the first motor assembly displaces the first diaphragm in a first positive direction oriented away from the first motor assembly and away from the second diaphragm; and the second motor assembly displaces the second diaphragm in a second positive direction oriented away from the second motor assembly and away from the first diaphragm.

Example 6: The apparatus of example 1, wherein: the first motor assembly displaces the first diaphragm in a first positive direction oriented away from the first motor assembly and towards the second diaphragm; and the second motor assembly displaces the second diaphragm in a second positive direction oriented away from the second motor assembly and away from the first diaphragm; or the first motor assembly displaces the first diaphragm in a first positive direction oriented away from the first motor assembly and away from the second diaphragm; and the second motor assembly displaces the second diaphragm in a second positive direction oriented away from the second motor assembly and towards the first diaphragm.

Example 7: The apparatus of example 1, wherein the first motor assembly and the second motor assembly contemporaneously displace the first diaphragm and the second diaphragm in the first positive direction and the second positive direction, respectively.

Example 8: The apparatus of example 1, wherein: the at least one aperture comprises a first aperture and a second aperture; and the at least one acoustic cavity comprises a first acoustic cavity adjacent to the first aperture and a second acoustic cavity adjacent to the second aperture.

Example 9: The apparatus of example 8, wherein: the first diaphragm faces inward toward the first acoustic cavity; and the second diaphragm faces inward toward the second acoustic cavity.

Example 10: The apparatus of example 1, further comprising: a first rear volume adjacent to the first motor assembly on a side opposite to the first diaphragm; and a second rear volume adjacent to the second motor assembly on a side opposite to the second diaphragm.

Example 11: The apparatus of example 10, wherein the first rear volume and the second rear volume are a same rear volume.

Example 12: The apparatus of example 1, wherein the first motor assembly and the second motor assembly comprise a conjoined motor assembly.

Example 13: The apparatus of example 1, wherein the at least one acoustic cavity is configured to cause intermodulation distortion effects arising at the first and second diaphragms to substantially offset each other at the at least one aperture.

Example 14: A method comprising: receiving, by a hearable device, an audio signal; converting, by the hearable device, the audio signal to an electrical signal; actuating, based on the electrical signal, at least one motor assembly; displacing, by the at least one motor assembly, at least one diaphragm; compressing, by the displacing of the at least one diaphragm, air to produce a compressed sound wave; and rarefying, by the displacing of the at least one diaphragm, air to produce a rarefied sound wave.

Example 15: The method of example 14, wherein the audio signal comprises volume information and frequency information.

Example 16: The method of example 14, wherein the audio signal is a digital signal or an analog signal.

Example 17: The method of example 14, wherein: the at least one motor assembly comprises a first motor assembly and a second motor assembly; the at least one diaphragm comprises a first diaphragm and a second diaphragm; the first motor assembly displaces the first diaphragm; and the second motor assembly displaces the second diaphragm.

Example 18: The method of example 17, wherein: the displacements of the first and second diaphragms compress air contemporaneously to produce first and second compressed sound waves; or the displacement of the first and second diaphragms rarefy air contemporaneously to produce first and second rarefied sound waves.

Example 19: The method of example 18, wherein: the hearable device combines the first and second compressed sound waves to produce a combined compressed sound wave; or the hearable device combines the first and second rarefied sound waves to produce a combined rarefied sound wave.

Example 20: A hearable device comprising: the apparatus of example 1; one or more processors; and memory storing: instructions that, when executed by the one or more processors, cause the one or more processors to implement the method of example 14.

### CONCLUSION

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The entities of FIGS. 1 through 8 may be further divided, combined, used along with other sensors or components, and so on. In this way, different implementations of the apparatus including the micro-speakers 106 having the forward roll surround 108-1 and the reverse roll surround 106-2, with different configurations of the housing 604, the acoustic cavities 606, and the apertures 608, can be used to reduce intermodulation distortion effects in hearable devices. The example operating environment 100 of FIG. 1, the detailed illustrations of FIGS. 2 through 7F, and the method of FIG. 8 illustrate some of many possible environments and apparatuses capable of employing the described techniques.

Although implementations of apparatuses and systems related to reducing IMD effects in hearable devices have been described in language specific to features and/or methods described herein, it is to be understood that the subject of the appended claims is not necessarily limited to the specific features or methods described. Rather, the specific features and methods are disclosed as example implementations of apparatuses and systems related to reducing IMD effects in hearable devices.

What is claimed is:

1. An apparatus comprising:
a housing having at least one aperture;
at least one acoustic cavity disposed within the housing, the at least one acoustic cavity adjacent to the at least one aperture;
a first micro-speaker disposed within the housing, the first micro-speaker comprising:
a first frame coupled to the housing;
a forward roll surround having a convex-shaped cross-section oriented convexly into the at least one acoustic cavity, the forward roll surround coupled to the first frame;
a first diaphragm disposed about a first excursion axis, the first diaphragm facing the at least one acoustic cavity and coupled to the forward roll surround; and
a first motor assembly disposed about the first excursion axis and operably coupled to the first diaphragm; and
a second micro-speaker disposed within the housing, the second micro-speaker comprising:
a second frame coupled to the housing;
a reverse roll surround having a concave-shaped cross-section oriented concavely into the at least one acoustic cavity, the reverse roll surround coupled to the second frame;
a second diaphragm disposed about a second excursion axis, the second diaphragm facing the at least one acoustic cavity and coupled to the reverse roll surround; and
a second motor assembly disposed about the second excursion axis and operably coupled to the second diaphragm.

2. The apparatus of claim 1, wherein the first excursion axis and the second excursion axis are not coaxial.

3. The apparatus of claim 1, wherein the first excursion axis and the second excursion axis are coaxial.

4. The apparatus of claim 1, wherein:
the first motor assembly displaces the first diaphragm in a first positive direction oriented away from the first motor assembly and towards the second diaphragm; and
the second motor assembly displaces the second diaphragm in a second positive direction oriented away from the second motor assembly and towards the first diaphragm.

5. The apparatus of claim 1, wherein:
the first motor assembly displaces the first diaphragm in a first positive direction oriented away from the first motor assembly and away from the second diaphragm; and
the second motor assembly displaces the second diaphragm in a second positive direction oriented away from the second motor assembly and away from the first diaphragm.

6. The apparatus of claim 1, wherein:
the first motor assembly displaces the first diaphragm in a first positive direction oriented away from the first motor assembly and towards the second diaphragm; and
the second motor assembly displaces the second diaphragm in a second positive direction oriented away from the second motor assembly and away from the first diaphragm; or
the first motor assembly displaces the first diaphragm in a first positive direction oriented away from the first motor assembly and away from the second diaphragm; and
the second motor assembly displaces the second diaphragm in a second positive direction oriented away from the second motor assembly and towards the first diaphragm.

7. The apparatus of claim 1, wherein the first motor assembly and the second motor assembly contemporaneously displace the first diaphragm and the second diaphragm in the first positive direction and the second positive direction, respectively.

8. The apparatus of claim 1, wherein:
the at least one aperture comprises a first aperture and a second aperture; and
the at least one acoustic cavity comprises a first acoustic cavity adjacent to the first aperture and a second acoustic cavity adjacent to the second aperture.

9. The apparatus of claim 8, wherein:
the first diaphragm faces inward toward the first acoustic cavity; and
the second diaphragm faces inward toward the second acoustic cavity.

10. The apparatus of claim 1, further comprising:
a first rear volume adjacent to the first motor assembly on a side opposite to the first diaphragm; and
a second rear volume adjacent to the second motor assembly on a side opposite to the second diaphragm.

11. The apparatus of claim 10, wherein the first rear volume and the second rear volume are a same rear volume.

12. The apparatus of claim 1, wherein the first motor assembly and the second motor assembly comprise a conjoined motor assembly.

13. The apparatus of claim 1, wherein the at least one acoustic cavity is configured to cause intermodulation distortion effects arising at the first and second diaphragms to substantially offset each other at the at least one aperture.

14. A method comprising:
receiving, by a hearable device, an audio signal;
converting, by the hearable device, the audio signal to an electrical signal;
actuating, based on the electrical signal, at least one motor assembly;
displacing, by the at least one motor assembly, at least one diaphragm;
compressing, by the displacing of the at least one diaphragm, air to produce a compressed sound wave; and
rarefying, by the displacing of the at least one diaphragm, air to produce a rarefied sound wave.

15. The method of claim 14, wherein the audio signal comprises volume information and frequency information.

16. The method of claim 14, wherein the audio signal is a digital signal or an analog signal.

17. The method of claim 14, wherein:
the at least one motor assembly comprises a first motor assembly and a second motor assembly;
the at least one diaphragm comprises a first diaphragm and a second diaphragm;
the first motor assembly displaces the first diaphragm; and
the second motor assembly displaces the second diaphragm.

18. The method of claim 17, wherein:
the displacements of the first and second diaphragms compress air contemporaneously to produce first and second compressed sound waves; or
the displacement of the first and second diaphragms rarefy air contemporaneously to produce first and second rarefied sound waves.

19. The method of claim 18, wherein:
the hearable device combines the first and second compressed sound waves to produce a combined compressed sound wave; or
the hearable device combines the first and second rarefied sound waves to produce a combined rarefied sound wave.

20. A hearable device comprising:
at least one diaphragm;
at least one motor assembly operably coupled to the at least one diaphragm;
one or more processors; and
memory storing instructions that, when executed by the one or more processors, cause the one or more processors to:
receive an audio signal;
convert the audio signal to an electrical signal;
actuate, based on the electrical signal, the at least one motor assembly; and
cause the at least one motor assembly to displace at least one diaphragm wherein the displacement of the at least one diaphragm compresses air to produce a compressed sound wave and rarefies the air to produce a rarefied sound wave.
